(19) United States
(12) Patent Application Publication
(10) Pub. No.: US 2005/0179811 A1
(43) Pub. Date: Aug. 18, 2005

(54) Video recording system utilizing Miniature Digital Camcorder

(76) Inventor: Dennis Palatov, Portland, OR (US)

Correspondence Address: Dennis Palatov, 1315 SW Rivington Dr., Portland, OR, 97201, US

(21) Appl. No.: 10/708,167

(22) Filed: Feb. 12, 2004

(51) Int. Cl. H04N 5/225; H04N 5/232

(52) U.S. Cl. 348/373; 348/211.2

(57) ABSTRACT

A video recording system utilizing one or more Miniature Digital Camcorders (MDC) which facilitates recording digital video of user's activity without diverting the user's attention from said activity or encumbering the user's performance of the activity. A wireless Remote Control allows controlling the start and stop function of one or more MDC units without distraction from the activity. Due to multiple MDC units responding to commands from a single Remote Control, the video captured by all such units is automatically synchronized. The video thereby created is suitable for subsequent transfer to a Personal Computer for viewing and editing.

### BACKGROUND OF INVENTION

Presently there exists a rising popularity of various specialized extreme sports, from mountain biking to skate-boarding to skydiving. As more people participate in such activities they are desiring to have a video record of the experience and to share this video with others, possibly via the Internet. Due to often dangerous nature of such sports activities, the full attention of the participant must be on the activity. Currently available video equipment requires that the person recording the video devote attention to the task of recording. It is therefore generally difficult or impossible for a sports participant to personally record video of his or her activity. Recently, some solutions have emerged that may be acceptable, though not ideal, for some forms of sports. Such solutions typically involve a compact analog camera in a rugged enclosure, sized so as to be readily mountable on a user's helmet or equipment, said camera being simultaneously connected to an external power source and to a video recorder, both of which are typically mounted in a backpack or a similar enclosure. There are many drawbacks to this approach, the most important ones being that the equipment is still bulky, cumbersome to use, fragile and expensive. Some solutions have improved on the above concept with a wireless link between camera and recording equipment, eliminating cables but further adding to bulk and cost. Alternatively, many of the currently available compact digital still cameras have video recording capability. Unfortunately the design of such digital cameras presently requires the user to hold and operate the camera in order to insure the subject of the video is in view. Said cameras are designed around a paradigm that places the user's attention on the process of taking a picture or video clip, rather than on the activity being thereby recorded. What is needed is a simple, rugged Miniature Digital Camcorder (MDC) capable of recording video with no user interaction except to start and stop the recording. The MDC should be sufficiently small and lightweight so as to be directly mountable to the user's sports equipment such as a helmet or a bicycle or a skateboard. The size of the MDC should preferably not exceed the dimensions of 1″×2″×3″ with the lens located on smallest face to reduce profile and minimize the chance of damage or interference with the activity being recorded. The device should be inexpensive in order to reduce costs of possible loss or damage and to facilitate simultaneous use of multiple units by ordinary consumers. The MDC should be rugged enough to withstand substantial shock and vibration inherent in sports activities, while recording video. The MDC enclosure should be at least weather-resistant and preferably waterproof. Preferably the start and stop functions of the MDC should be operable by a user wearing gloves. Further, such start and stop functions should be operable without visual reference, for example when the MDC is mounted on a user's helmet or remotely on a vehicle. The MDC should be capable of recording at least one half hour of video of a quality suitable for viewing on a personal computer. The MDC should have a simple mechanism for transferring video to a personal computer for viewing, editing and uploading to the Internet.

### SUMMARY OF INVENTION

A primary objective of the present invention is to provide a compact, simple to operate and rugged video recording system that allows its user unhindered participation in an intense or demanding activity while recording a digital video of such activity without diverting any of user's attention or encumbering the user in any way. A second objective is to facilitate the simultaneous operation of multiple units of the present invention consistent with the primary objective. A third objective is to provide such a system at the lowest possible cost. To achieve these objectives, the video recording system and Miniature Digital Camcorder (MDC) of the present invention provide several key features. The MDC integrates the image acquisition, processing and storage systems, along with a power system, in a single compact enclosure. This ensures the MDC is directly mountable to user's equipment, such as a helmet or a bicycle. The MDC of the present invention is sufficiently compact and lightweight as to not encumber the user in the performance of the activity being recorded or to restrict the user's motion in any way. The MDC enclosure does not incorporate any user-operable controls. The elimination of user-operable controls serves to improve ruggedness and reduce cost. Control functions of the preferred embodiment are limited to Start and Stop and are accomplished by means of a miniature wireless Remote Control unit using RF technology. The Remote Control unit is designed in such a way as to prevent confusion of the functions and to be operable while wearing gloves, as described in detail elsewhere in this document. Further, in the preferred embodiment the controls are operable with a simple movement of the user's thumb, presenting minimal distraction to the user. A Remote Control unit of the present invention incorporates a unique ID code, and several MDC units can be programmed to respond exclusively to commands from a Remote Control unit with a particular ID code, thereby enabling simultaneous operation of several MDC units without causing interference to or receiving interference from other such systems that may be operated by other users nearby.

The MDC of the present invention is intended for the creation of digital video which is to be transferred to a personal computer for viewing, editing and uploading to the Internet. The MDC is completely solid state and has no moving parts with the possible exception of lens focusing mechanism. This serves to improve its shock resistance, battery life and ease of use. No facility for viewing the recorded video is provided. This contributes to lower cost, enhanced reliability and further simplified operation. It is expected that the user shall employ one or more MDC devices in conjunction with a single Remote Control unit to make a video record of an activity, subsequently editing the resulting video on a personal computer for later viewing or uploading to the Internet. By combining compact size, low weight, ruggedness and ease of operation the MDC of the present invention allows its user to devote full attention to the activity being recorded while creating a digital video record of the activity.

### BRIEF DESCRIPTION OF DRAWINGS

The present invention is described herein with reference to the following drawings:

FIG. 1 Is a block diagram of MDC of the present invention comprising an Optical Lens, an Image Sensor, a CPU, a Storage Subsystem, a Power Subsystem, an Internal Clock, the MDC being in communication with a Remote Control Unit by means of Communications Link.

FIG. 2 Shows the Enclosure of the present invention having a Cover to protect the removable Storage Subsystem and Power Subsystem and having a removable transparent cover to protect the Optical Lens.

FIG. 3 Shows a video recording system of the present invention comprising a plurality of MDC units, a single Audio Recorder unit and a single Remote Control Unit.

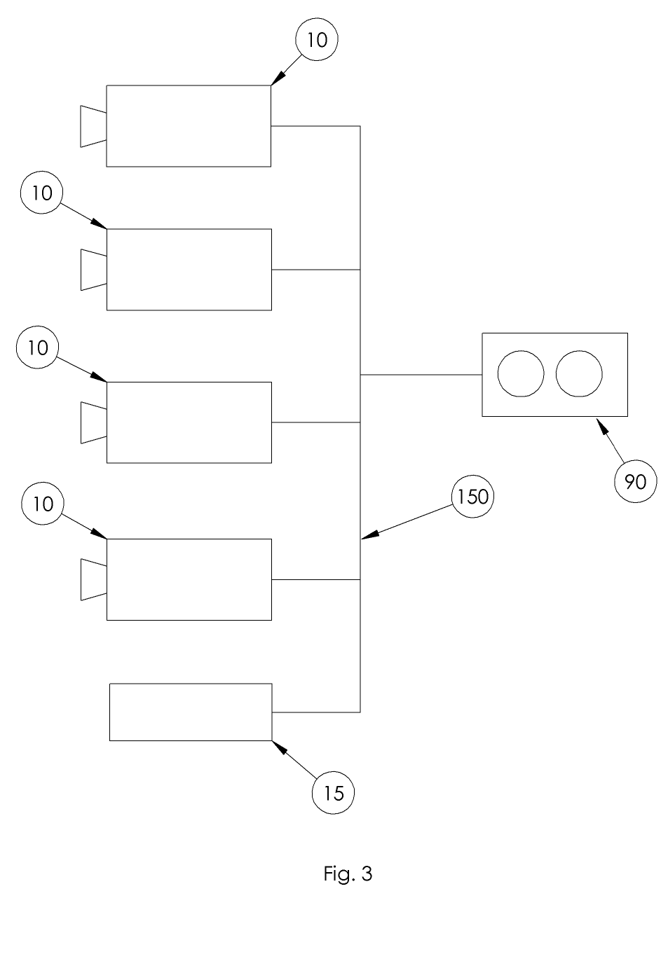

FIG. 4 Illustrates a Remote Control unit of the present invention having a Start Button, a Stop button and an elastic band.

FIG. 5 Shows a Remote Control unit of the present invention mounted on a user's index finger and operable by a user's thumb.

FIG. 6 Is a flow diagram of the Initialization and Operation Processes of the MDC of the present invention.

### DETAILED DESCRIPTION

The preferred embodiment of the video recording system of the present invention is one or more Miniature Digital Camcorders 10, each in an injection-molded plastic Enclosure 200 of approximately 0.75″ in height, 2.0″ in width and 3.0′ in depth, accompanied by a single miniature wireless Remote Control unit 90. The dimensions and materials described herein are only illustrative of what is presently achievable using readily available components and are not limiting.

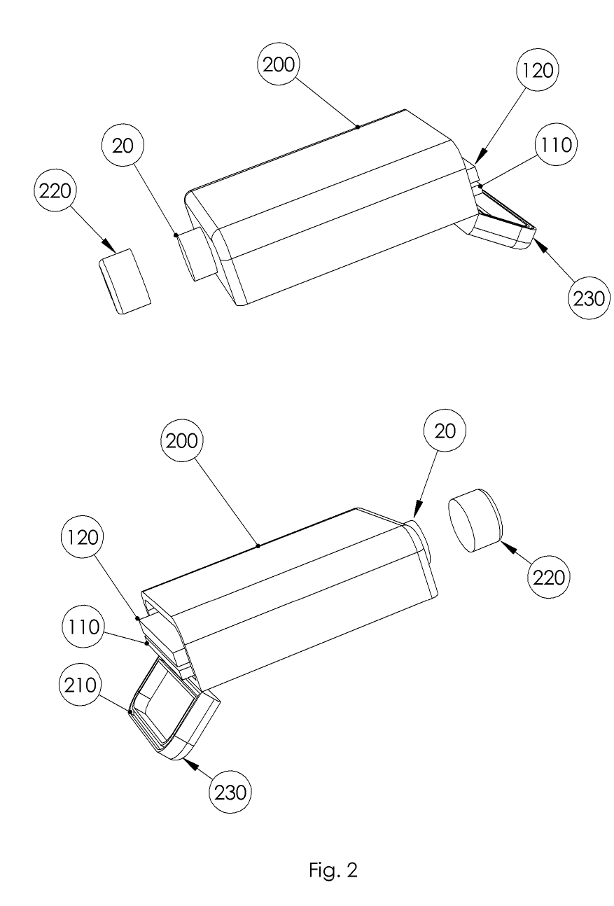

An Optical Lens 20 and integral Image Sensor 30 of CCD or similar type are located on one 0.75″×2.0″ face of the Enclosure 200. Numerous examples of lenses and sensors are known in the art and integrated optics and sensor packages are readily available from a number of vendors. Such lenses may have fixed or electromechanically variable focal length. They shall not be described herein. A replaceable transparent Lens Cover 220, shown in FIG. 2, may be incorporated in front of the Optical Lens to protect it from damage, and may have a tint to perform a filtering function.

The preferred embodiment further incorporates a CPU 100 capable of interfacing to the Image Sensor 30 and encoding digital video from images received from the Image Sensor in real time. A number of such CPUs are presently available from several semiconductor vendors and many examples of video encoding algorithms exist in the art. Such CPUs and algorithms are widely used in digital cameras and the like.

A third component of the preferred embodiment is a Storage Subsystem 110 capable of storing the digital video data generated by the CPU 100 in real time. This Subsystem is preferably implemented industry-standard FLASH memory of at least 256 Megabyte capacity and packaged in an industry-standard card format. A number of standard memory card formats are available, including but not limited to Compact FLASH, Smart Media, SD, SonyStick and the like. Preferably the storage subsystem is removable, as set forth in the above referenced standards, to facilitate convenient transfer of digital video to a personal computer. Additionally, a standard digital serial bus interface, such as IEEE-1394 or USB may be incorporated in the MDC to facilitate such transfer.

Another part of the MDC is the Power Subsystem 120, preferably consisting of a Lithium-Ion rechargeable battery and removable. Many examples of such batteries are known in the art. The charging of the battery may be accomplished in the MDC via customary means or by utilizing an external charger.

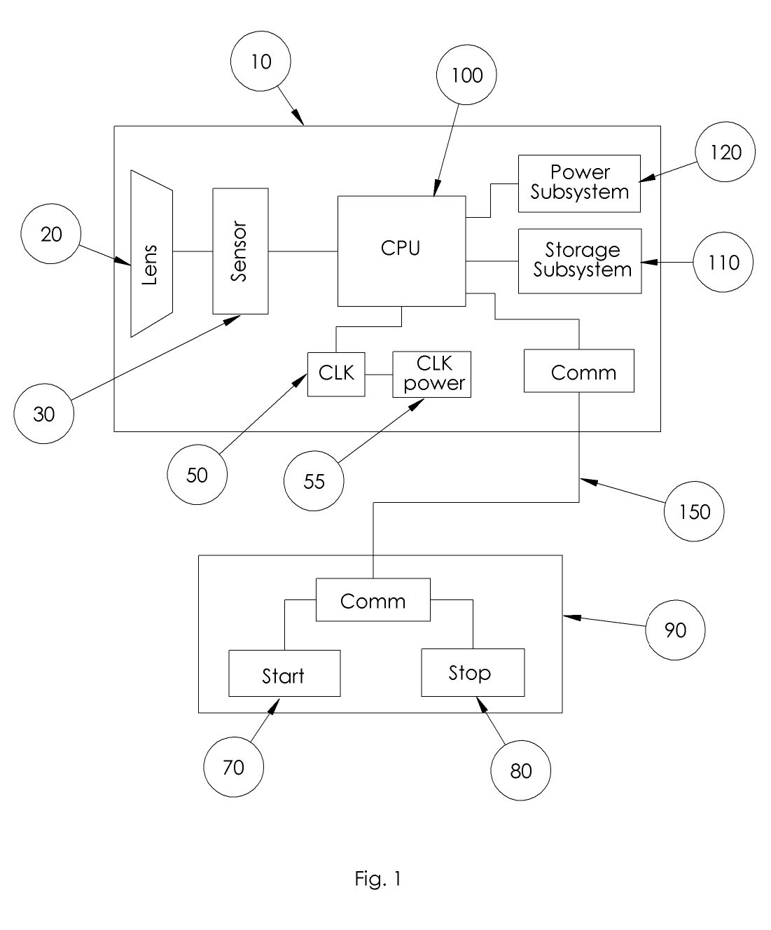

The above-described Optical Lens 20, Image Sensor 30, CPU 100, Storage Subsystem 110 and Power subsystem 120 are all combined in the Enclosure 200 of the MDC 10, as illustrated schematically in FIG. 1.

The Enclosure of the MDC in the preferred embodiment is mountable to user's equipment via readily available means such as adhesive-backed hook-and-loop fastener strips. Preferably, a fastener strip applied to Enclosure mates with a complementary fastener strip applied to the desired location on the user's equipment to securely retain the MDC to such equipment. The mounting strips, once placed, may be used as references in positioning the MDC on subsequent removal and re-attachment. Other mounting methods, such as metal or plastic fasteners, adhesives and the like are possible. The Enclosure 200 of the preferred embodiment preferably provides a Protective Cover 230 for the removable Storage Subsystem and Power Subsystem, and preferably further incorporates a Seal 210 to make this cover waterproof when closed, as shown in FIG. 2. Such covers and seals are common in a variety of applications, particularly in underwater photographic equipment, and are not described herein.

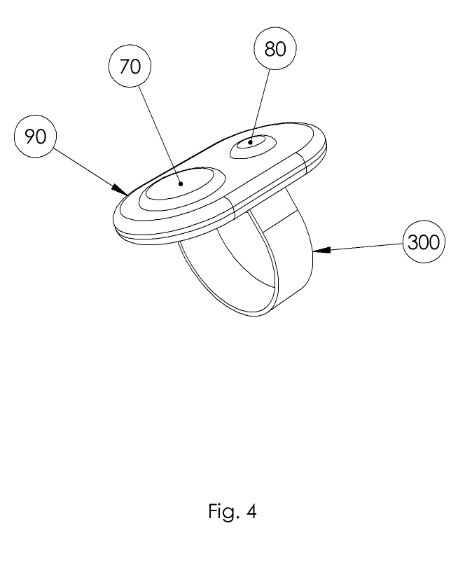

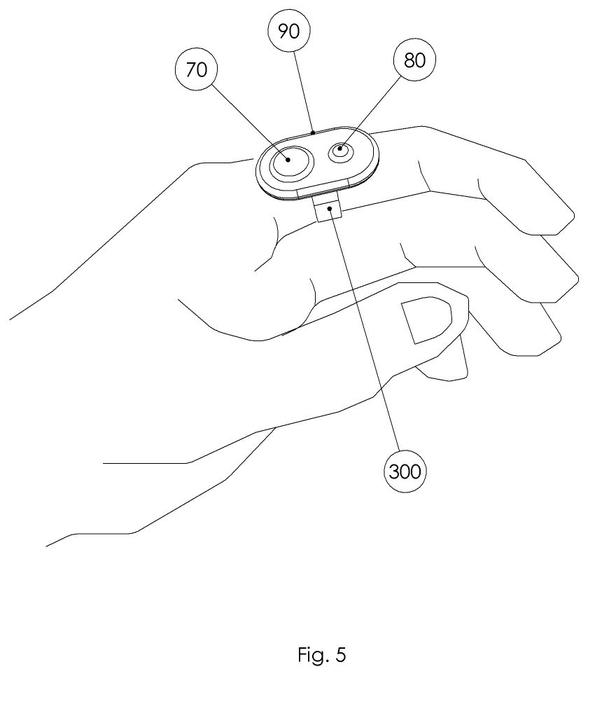

A final component of the video system of the present invention is the Control Subsystem, which is preferably in the form of a wireless Remote Control unit 90 (shown schematically in FIG. 1 and further illustrated in FIG. 4 and FIG. 5) utilizing RF technology for its Communications Link 150, shown schematically in FIG. 1, with one or more MDC units. RF technology is preferable to Infrared commonly used for remote control functions due to not having a requirement of line-of-sight operation. The communication between the Remote Control unit and the MDC unit may also be accomplished by means of a cable, although such arrangement is undesirable under the preferred embodiment. The Remote Control unit of the present invention incorporates two distinct controls in the form of pushbuttons, a Start Control 70 to start recording of video and a Stop Control 80 recording. These buttons are sized and positioned so as to be easily operable by a person wearing gloves, as illustrated in FIG. 4 and FIG. 5. The Remote Control 90 of the preferred embodiment is sized approximately 1″ long, ½″ wide and ¼″ thick, with Start and Stop buttons co-located on one face. The Remote control is preferably mountable on user's index finger by means of a Flexible Band 300 and is positioned so as to be operable by user's thumb, as shown in FIG. 5. The starting and stopping of video recording can therefore be accomplished without first visually identifying the controls and indeed without the user having to move either hand. The user consequently is able to control the video recording system of the present invention while safely operating a vehicle or otherwise utilizing hands in the activity being recorded.

The Remote Control unit of the present invention preferably utilizes industry-standard low power Radio Frequency technology used in such applications as remote keyless entry (RKE) systems in automobiles, to facilitate operation of a MDC that is mounted outside of the user's comfortable reach and possibly out of line of sight. In the preferred embodiment, a Remote Control unit is preconfigured at the time of manufacture to transmit its commands with an ID code that is unique to a particular Remote Control unit. One or more MDC units may there-after be programmed by the user to respond to the commands of a particular Remote Control unit by responding only to commands containing its unique ID code. This feature allows the operation of one or more MDC units with a single Remote Control unit without interference to any MDC units that may be simultaneously operated by other users in the immediate vicinity. Such unique codes are well known in the art and are widely utilized in remote keyless entry applications and are therefore not described herein.

Whenever both an active Power Subsystem and a Storage Subsystem are inserted, the MDC completes the Initialization Process, described below, and enters a low power Standby Mode. In this mode the CPU is dormant, waking up periodically to check for the presence of a valid Command from the Remote Control unit. In Standby Mode the MDC will only respond to a valid Start Command incorporating the unique ID code of the Remote Control unit which the MDC has been configured to respond to. Upon receipt of such Start Command the MDC will enter Recording Mode, acquiring image data from the Image Sensor, digitally encoding the information in a predetermined industry-standard format such as MPEG and storing the encoded video in the Storage Subsystem. This recording will continue until either a valid Stop Command is received by the MDC or the capacity of the Storage Subsystem is exhausted. It is also possible to configure the MDC to record continuously, overwriting the oldest stored information using a circular file system, in which case the recording will not terminate upon exhausting the Storage Subsystem capacity. Many examples of circular file systems exist in the art and as such need not be described here. While in Recording Mode the MDC will only respond to a valid Stop Command from the Remote Control unit. Upon termination of Recording Mode the MDC will reenter Standby Mode. The recorded video is subsequently transferred to a Personal Computer by means of removing the Storage Subsystem from the MDC and connecting it to a Personal Computer via industry-standard means such as a card reader or an adapter. The video data is then transferred to the Personal Computer by customary means and may be viewed and edited using commonly available programs.

The MDC of the present invention may have several configurable Operating Parameters that the user may wish to change. Such Operating Parameters may include the ID code of the Remote Control unit that MDC responds to. Additionally, Operating Parameters such as lens zoom settings and encoded video resolution and compression settings may need to be configured based on user requirements. Since the MDC of the present invention lacks user-operable controls to improve ruggedness and reduce cost, a method is needed for configuring Operating Parameters. In the preferred embodiment, this method takes advantage of the removable Storage Subsystem. Other methods are possible, such as incorporating an industry-standard communications bus in the MDC for communicating with a Personal Computer, or transmitting the information wirelessly. However most of such methods may increase cost and could therefore be contrary to the third objective of the present invention. In the preferred embodiment, a Configuration File of a predetermined format is created on a Personal Computer. This Configuration File may be created with the aid of a custom application program or by means of a text editor. Many such programs exist in the art and need not be described here. The Configuration File contains a separate entry for each Operating Parameter to be configured. The Storage Subsystem is first removed from the MDC and connected to the Personal Computer, as previously described. The Configuration File is then transferred from the Personal Computer to the Storage Subsystem. A predetermined file name identifies the Configuration File as such. The Storage Subsystem is then inserted in the MDC and the Configuration File is utilized during the Initialization Process, described below, to configure the desired Operating Parameters.

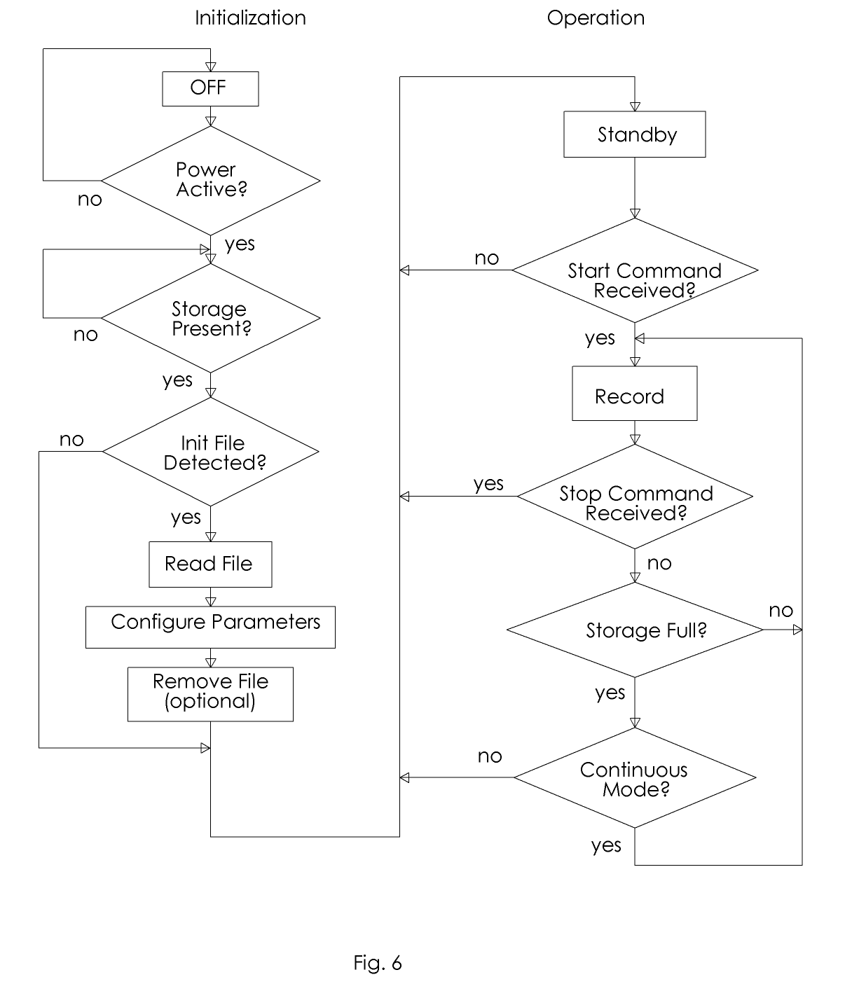

The Initialization Process of the MDC of the present invention, illustrated as a flowchart in FIG. 6, begins when the second of a Storage Subsystem and an active (charged) Power Subsystem is inserted into the MDC. First, the Storage Subsystem is checked for the presence of a valid Configuration File. If no such file is detected, the MDC enters Standby Mode with no changes to its previously configured Operating Parameters. If a valid Configuration File is found, the information contained therein is used to configure Operating Parameters. If a change in Optical Lens focus setting is required it is carried out at this time. The new configuration of the Operating Parameters is saved in onboard non-volatile Configuration Memory, which is preferably a FLASH memory, for subsequent use. Upon completion of the Initialization Process the Configuration File is removed from the Storage Subsystem in order to conserve space and prevent unnecessary duplicate re-configuration. If more than one MDC unit is to be configured using a single Storage Subsystem then the Configuration File may optionally contain a specific code that instructs the MDC not to remove it after completing the Initialization Process. This would allow subsequent insertion of the same Storage Subsystem in additional MDC units to configure their Operating Parameters with the same information.

The MDC of the present invention may further incorporate an Internal Clock 50 capable of sending a signal to the CPU 100. Such Internal Clocks are commonly incorporated in digital electronic equipment and typically used to keep track of calendar date and time of day, as well as to provide timer and alarm functions. A typical Internal Clock has a Power Source 55 independent of the Power Subsystem 120 which allows the Internal Clock to accurately keep track of calendar date and time even in the absence of an active Power Subsystem. An Operating Parameter may then be defined to alter the MDC unit's response to a valid Start Command based on a signal from the Internal Clock, such as introducing a delay in the response by a predetermined amount. Additionally, the MDC may be instructed to use a signal from the Internal Clock in lieu of either or both of the Start Command and Stop Command. This feature may for example be used to start recording at a predetermined time following a valid Start Command, or a predetermined calendar date and time of day, and to stop recording at a predetermined time thereafter, or to record periodically at predetermined intervals for a predetermined length of time, thereby implementing an unattended recording mode. The Operating Parameter for such unattended operation, herein referred to as a Timed Operating Parameter, may be configured using the earlier-described procedure. The calendar date and time of the Internal Clock may be set at the time of manufacture to a predetermined time zone, which may be GMT, and the local time may be set by configuring a Local Time Zone Operating Parameter. Subsequently, the Timed Operating Parameter for unattended operation is configurable with reference to local calendar date and time.

The MDC of the present invention may further incorporate a microphone and audio amplifier to facilitate the recording of sound along with video. Such arrangements are common in the art and need not be described here. Alternatively, the video recording system of the present invention may incorporate a separate Audio Recorder unit 15, with its own Power Subsystem and Storage Subsystem. Such Audio Recorder (AR) would be programmable to respond to the Start and Stop commands of the same Remote Control unit as the MDC. The audio and video records can then be combined at a later time using a Personal Computer. Synchronization between audio and video records is achieved by ensuring that both AR and MDC have substantially similar response times to Start and Stop commands from the Remote Control unit. The use of a separate AR is advantageous in situations where MDC would be exposed to the elements or excessive wind blast, or in situations where unique placement of a microphone is desired. An example of the latter would be placing the AR inside a user's helmet to facilitate recording of user commentary. The use of a self-contained AR eliminates the need for wires and provides maximum flexibility in placement without any encumberance to the user, consistent with the objectives of the present invention.

The preferred embodiment of the present invention described herein is illustrative and not limiting. Other embodiments may become apparent to persons skilled in the art based on the teaching of the present invention without departing from it in scope and spirit.

1. a video recording system comprising:
A MDC further comprising:
An Optical Lens;
An Image Sensor;
A CPU capable of real time encoding of digital video from data generated by said Image Sensor;
A solid state Storage Subsystem capable of storing said digitally encoded video;
A Power Subsystem; and
An Enclosure;
A miniature Remote Control unit further comprising at least:
A Start control; and
A Stop control;
and
A Communications Link;
Said MDC being responsive to commands transmitted by said Remote Control unit by means of said Communications Link, said commands further comprising at least:
A Start command; and
A Stop command;
Said MDC not having a means for viewing said encoded digital video;

2. A video recording system of claim 1, said MDC not having user-operable controls.

3. A video recording system of claim 1 wherein said Storage Subsystem of said MDC is removable.

4. A video recording system of claim 1 wherein said Communication Link is wireless.

5. A video recording system of claim 1 wherein said Communication Link is a cable.

6. A video recording system of claim 1 wherein said Power Subsystem is a battery.

7. A video recording system of claim 1 wherein said Remote Control unit is configured so as to be mountable on user's index finger and operable by user's thumb.

8. A video recording system of claim 1 wherein said Enclosure of said MDC is less than six cubic inches in volume.

9. A video recording system of claim 1 wherein said Enclosure of said MDC is waterproof.

10. A video recording system of claim 1, further comprising an Audio Recorder, said Audio Recorder comprising at least:
A microphone;
A Power Subsystem; and
A Storage Subsystem;
Said Audio Recorder being responsive to Commands transmitted by said Remote Control unit by means of said Communications Link.

11. A video recording system comprising:
A Remote Control unit;
A plurality of MDC units; and
A wireless Communications Link;
Said plurality of MDC units being responsive to Commands transmitted by said Remote Control unit by means of said Communications Link;
Said Remote Control unit having a predetermined unique ID code;
Said Commands comprising at least said unique ID code; Said plurality of MDC units configurable to respond exclusively to Commands comprising said unique ID code.

12. A method of configuring a MDC having at least an Operating Parameter,
Said MDC not having user operable controls,
Said MDC comprising at least a removable Storage Subsystem,
Said method comprising the steps of:
A. Creating a Configuration File on a Personal Computer;
B. Removing said Storage Subsystem from said MDC;
C. Placing said Storage Subsystem in communication with said Personal Computer;
D. Transferring said Configuration File to said Storage Subsystem;
E. Installing said Storage Subsystem in said MDC;
F. Configuring said Operating Parameter of said MDC responsive to Information contained in said Configuration File.

13. A method of claim 12 further comprising the step of removing said Configuration file from said Storage Subsystem.

14. A method of claim 12, said MDC further comprising an Internal Clock, said Configuration File further comprising Information to configure at least a Timed Operating Parameter, said Timed Operating Parameter causing said MDC to be responsive to a signal from said Internal Clock.

15. A method of claim 14, wherein said Internal Clock is configured to a Calendar Date and Time of a Predetermined Time Zone, said Calendar Date and Time being current at the time of manufacture of said MDC.

16. A method of claim 15 wherein said Predetermined Time Zone is GMT.

17. A method of claim 16, said MDC having at least a Local Time Zone Operating Parameter, said Timed Operating Parameter being configured with reference to said Internal Clock and with further reference to said Local Time Zone Operating Parameter.
